(19) United States
(12) Patent Application Publication
(10) Pub. No.: US 2014/0279416 A1
(43) Pub. Date: Sep. 18, 2014

(54) SIGNATURE BASED TRANSACTION GROUP PROCESSING AND REAL-TIME SCORING

(71) Applicant: SAS Institute Inc., Cary, NC (US)

(72) Inventors: Ho Ming Luk, San Diego, CA (US); Kannan Shah, San Diego, CA (US); Olcay Boz, San Diego, CA (US)

(21) Appl. No.: 13/840,047

(22) Filed: Mar. 15, 2013

Related U.S. Application Data
(60) Provisional application No. 61/785,942, filed on Mar. 14, 2013.

(51) Int. Cl. G06Q 40/00

(52) U.S. Cl. CPC G06Q 40/00
USPC 705/39

(57) ABSTRACT

A transaction in a sequence of transactions is received and a transaction group with which the transaction is associated is determined, as well as transaction group signature data of the transaction group with which the received transaction is associated. A transaction score for the received transaction is generated, in response to determining that the received transaction is a last transaction in the transaction group with which the received transaction is associated, and a transaction group score is generated for the transaction group with which the received transaction is associated, such that the transaction group score is generated based on all transactions in the sequence of transactions that are associated with the transaction group.

### CROSS-REFERENCE TO RELATED APPLICATIONS

This application claims priority to U.S. Provisional Application No. 61/785,942 to Ho Ming Luk, Kannan Shah, and Olcay Boz filed Mar. 14, 2013 entitled “Signature Based Transaction Group Processing And Real-Time Scoring”, which is incorporated herein by reference in its entirety.

### TECHNICAL FIELD

The present disclosure generally relates to the processing of financial transactions.

### BACKGROUND

The processing of financial transactions, such as credit card transaction processing, fund transfers, and check processing for clearance by financial institutions, typically can begin with receipt of a data record that contains multiple financial transactions or can involve processing a stream of received financial transactions. The stream of transactions can be processed such that each of the transactions may be processed as it is received, or the transactions in a portion of the incoming stream may all be processed before transactions in another portion are processed. Modern computer processing systems can efficiently process a given data record or transaction before moving on to process a subsequent one.

### SUMMARY

In some aspects, a transaction in a sequence of transactions is received and a transaction group with which the transaction is associated is determined, as well as transaction group signature data of the transaction group with which the received transaction is associated. A transaction score for the received transaction is generated. Moreover, a transaction group score may be generated for all transactions in a transaction group, in response to determining that the received transaction is a last transaction in the transaction group with which the received transaction is associated, such that the transaction group score is generated based on all transactions in the sequence of transactions that are associated with the transaction group.

Other features of the disclosed subject matter will be apparent from the following description of the embodiments, which illustrate, by way of example, the principles of the disclosed subject matter.

### BRIEF DESCRIPTION OF THE DRAWINGS

FIG. 1 is a block diagram of an example of a computer system that provides the features disclosed herein.

FIG. 2 is a flow diagram of an example of the processing performed by the system illustrated in FIG. 1.

FIG. 3 is a diagrammatic representation of an example of a data record processed by the system illustrated in FIG. 1.

FIG. 4 is a flow diagram showing an example of transaction group processing and scoring flow performed by the system illustrated in FIG. 1.

FIG. 5 is a flow diagram of an example showing the transaction group signature initialization processing performed by the system illustrated in FIG. 1.

FIG. 6 is a flow diagram of an example showing the transaction group signature update and transaction scoring processing performed by the system illustrated in FIG. 1.

FIG. 7 is a flow diagram of an example showing the transaction group aggregation and scoring processing performed by the system illustrated in FIG. 1.

FIG. 8 is a block diagram of an example showing a computer system that operates in the FIG. 1 system.

### DETAILED DESCRIPTION

Transaction processing may utilize processing techniques that permit the grouping of transactions based on arbitrary (e.g., user-defined) transaction characteristics, and may involve the calculation and use of group-level statistics in real-time decisioning, for example. This sort of approach could supply a holistic view of transaction behavior for decisioning. The processes involved might be based on interrelationships amongst transactions within a group, and the processes may contribute to efficiency and security, depending on characteristics of the transactions. In some implementations, the decisioning can be based on characteristics of the group. In some of these implemenations, a regular co-occurrance of transactions can be checked. For example, if a certain type of transaction usually always appears with a certain other type of transaction, this can be verified under such a transaction-group processing scheme. Similarly, other statistical characteristics of a group of transactions, such as sum, mean, or standard-deviation of amounts, or acceleration/velocity, for example, can be used for decisioning on the group as a whole. For example, transactions that originate from the same vendor or retailer may be processed in ways that are different from transactions that originate from other vendors or retailers. In the context of received commercial financial transactions, such as commercial ACH (automated clearing house) payments, for example, transactions may be collected together into a group or batch for payment processing of the collected transactions.

Note that the word “batch” as used herein does not indicate batch processing in the sense of an offline computer operation, rather, it indicates an association amongst some subset of transactions in a data stream. Such transaction batches, which may involve, for example, payroll payments and invoice payments, are often created in the format of a data file specification such as specified by the National Automated Clearing House Association (NACHA). The “batch” in this context represents a transaction-level grouping. The transaction group may be created around a common characteristic, such as a common originator, a common transaction date range, a common financial institution, or the like. The description provided herein relates to processing transactions in real time, as they are received, in an online manner. The transaction processing may, however, occur according to an offline, batch-processing scheme.

It is generally desirable that each transaction in a batch receives a score for a characteristic on which decision making can be based, such as a score for credit risk, fraud, or the like. It is also generally desirable that the batch as a whole batch receives a score for a corresponding similar characteristic, such as credit risk, fraud, or the like. Thus, it is desirable that the transaction score is returned in real time, so that decision making may be performed in view of, for example, the credit risk or fraud characteristic. It is similarly desired for the batch (transaction-level group) to receive a batch score in real time, for appropriate decision making. The system described herein could be used for generating a transaction-level score for each transaction, and, after the entire batch has been presented to the system, for generating a batch-level score for the entire group or batch, in real time, as the stream of transactions are received and processed. Moreover, the system can generate a score for the batch, that is, for the transaction group in the aggregate, based on all transactions in the sequence of transactions that are associated with the transaction group and independently of transactions in the sequence of transactions that are not associated with the transaction group

FIG. 1 is a block diagram of an example of a computer system that provides the features disclosed herein. FIG. 1 shows a transaction services system 102 constructed in accordance with the disclosure. A user computer 104 accesses the transaction services system 102 through an interface application 106 at the user computer. The interface application may include, for example, a Web browser or special purpose application installed at the user computer. The user computer 104 communicates with the transaction services system 102 over a communications network 108, such as the Internet or other data network. Alternatively, the interface application may be installed at a computer of the transaction services system, for direct communication.

FIG. 1 shows that the transaction services system 102 includes a transactions application 110, which receives the communications from the interface application 106. The received communications may include, for example, data records of financial transactions, requests for processing data records, report requests, and other operational commands of the transaction services system and the like. The communications received by the transactions services system may be processed as they are received, in real time. Such received communications may include transactions data, such as relating to individual financial transactions or collected transactions. The transaction services system 102 includes a transactions database 112 and a signatures database 114. The transactions database stores data records that may include information relating to the financial transactions, such as data that is compliant with the NACHA specification. The signatures database stores signature data relating to the transactions. The signature data may comprise entity-level signature data relating to entities, such as signature data relating to user signatures, account signatures, financial institution signatures, and the like, and the signature data may comprise transaction-level signature data relating to transactions, such as data relating to the transactions received for processing. Signature data for transactions is discussed in, for example, U.S. Pat. No. 7,788,195 to SAS Institute Inc., the assignee of the present application. U.S. Pat. No. 7,788,195 is incorporated herein by reference. The transactions application 110 utilizes the transactions database 112 and signatures database 114, as described further below.

FIG. 2 is a flow diagram of showing example of the processing performed by the system illustrated in FIG. 1. The system receives transactions in a sequence, or stream, of transactions. The system may be configured for real time processing, and each transaction may be in the form of a data record that includes data relating to a single transaction, such that the single transaction is processed (e.g., scored) before the next transaction is received. Alternatively, the system may also support processing of multiple financial transactions in a delayed or an offline manner, such that multiple transactions are arranged sequentially in time within a single received communication comprising a data record, which is processed after receipt. In the first operation of FIG. 2, indicated by the flow diagram box numbered 202, a transaction in the sequence of transactions received at the computing device of the system is processed, wherein the received transaction being processed is the next transaction in the sequence, and each subsequently received transaction is processed, in turn. The next operation, indicated by the flow diagram box numbered 204, involves determining whether the received transaction being processed is associated with a previously identified transaction group, or is associated with a new transaction group.

Identification of a new transaction group at box 204 may be achieved in a number of techniques. The box 204 processing may involve, for example, examining group header data that is associated with every transaction and included in the transaction data record, and determining that the group header data in the received transaction has not been previously received in the transaction stream or determining that the group header data in the received transaction includes one or more variables with a data value that indicates a previously unseen transaction group. That is, the group header data that identifies a transaction group may be determined by multiple data fields or multiple data values contained in the data transaction data record. For this technique, the group header data for the first transaction in a transaction group is different from the group header data in every previously received transaction and is also different from the group header data in every subsequently received transaction. The transactions in the same transaction group, however, will share a common data element or data value that indicates shared membership in, or association with, the same transaction group. Thus, with this technique, the system will keep track of received group header data values to identify a new value signifying a new transaction group, and also to recognize already-identified transaction groups, and subsequent members of such groups. Alternatively, the box 204 processing may involve determining the presence of a not-seen-before data field or variable that identifies the first transaction in a transaction group, such that other received transactions will not contain the not-seen-before data field or variable. Other suitable techniques will occur to those skilled in the art, in view of this disclosure.

In the case of a negative outcome at the decision box 204, indicating that the transaction is not associated with a previously identified transaction group, the next operation in FIG. 2, indicated by the flowchart box numbered 205, involves performing a group signature initialization process. That is, a negative outcome at the decision box 204 indicates that the received transaction is part of a new transaction group, for which group signature data is generated and associated with the received transaction. Processing then proceeds to box 207.

In the case of an affirmative outcome at the decision box 204, indicating that the transaction is associated with a previously identified transaction group, the next operation in FIG. 2, indicated by the flowchart box numbered 206, involves determining the previously identified transaction group with which the received transaction is associated, and retrieving the signature data for that transaction group. Processing then proceeds to box 207.

The next operation, indicated by the flow diagram box numbered 207, is to update transaction group signature data for the transaction group with which the received transaction is associated. If the received transaction was part of a new group, then the transaction group signature data was newly generated at box 205 and no update is needed to be generated. If the received transaction was associated with a previously identified transaction group, then the transaction group signature data for that transaction group is updated at box 207 with information from the received transaction being processed. The updated transaction group signature data is then stored into the signatures database 114 (FIG. 1). The next operation, at the box 208, involves generating a transaction score for the received transaction. After the transaction score is generated, the transaction score for the received transaction may be stored into the transactions database 112 (FIG. 1) and associated with the received transaction. The next operation, at box 210, involves determining whether the received transaction is identified as the last transaction in the associated transaction group.

Similarly to the group header data, identification of the last transaction of a transaction group at box 210 with group trailer data may be achieved in a number of techniques. The box 210 processing may involve, for example, examining group trailer data that is associated with every transaction and included in the transaction data record, and determining that the group trailer data in the received transaction has not been previously received in the transaction stream and indicates the last transaction in the associated group, or the box 210 may involve determining that the group trailer data in the received transaction includes a variable with a data value that indicates the last transaction in the associated transaction group. Alternatively, the box 210 processing may involve determining the presence of a not-seen-before data field or variable that identifies that the received transaction is the last transaction in the associated transaction group. Other suitable techniques will occur to those skilled in the art, in view of this disclosure.

In the case of a negative outcome at the box 210, indicating that the received transaction is not the last transaction in the group with which it is associated, the processing of the system returns to the box 202 for processing the next transaction in the stream of received transactions. In the case of an affirmative outcome at the box 210, indicating the received transaction being processed is the last transaction in the transaction group with which it is associated, then in the next operation of FIG. 2, indicated by the box numbered 212, the system generates a transaction group score for the transaction group with which the received transaction is associated. Thus, the transaction group score is generated based on all transactions in the sequence of transactions that are associated with each given transaction group. The transaction group score is typically generated independently of transactions in the sequence of transactions that are not associated with the transaction group. There may, however, be a relationship or interdependence between the transaction scores of different transaction groups, such as by an indirect relationship through entity level signatures that multiple transaction streams may have in common. Details of generating the transaction group score will depend on the transaction data with which the transactions services system operates, and may be generated, for example, in accordance with rules of the institution for which the system is processing the transactions.

After the transaction group score is generated at the box 212, the next operation is at box 214, where the system checks for the end of the transaction stream being processed. If the last transaction processed (i.e., the end of a transaction group) was not also the end of the transaction stream, a negative outcome at box 214, then the system receives the next transaction at box 202 and continues processing as described above. If the transaction last processed is also the last transaction in the stream, an affirmative outcome at 214, then operation of the system continues at 216, indicating the end of processing the transaction stream, whereupon other system processing may occur. In the FIG. 2 description above, a transaction may be “associated” with a transaction group, or with the beginning or end of a transaction group, by including in its data an identifier (e.g., a data field value) that informs the system of its status (e.g., group member, group header, group trailer) or otherwise indicates its association, or the association may be indicated by database management techniques well-known to those skilled in the art.

FIG. 3 is a diagrammatic representation of an example of a portion 300 of a stream of received transactions being processed by the system illustrated in FIG. 1. Time is represented along the vertical axis in FIG. 3, with time zero at the top of the drawing figure, with the stream sequence of transactions being received for processing illustrated with the earliest received transactions at the top of the drawing figure, and later-received transactions illustrated progressively toward the bottom of the drawing figure. The stream of transactions 300 may be received at the user computer 104 and submitted to the transaction services system 102, or may be received directly at the transaction services system 102. In either case, the received transactions stream 300 comprises a temporal sequence of transactions, such as data records relating to financial transactions. Each transaction record in the temporal sequence includes data associated with a financial transaction between a customer and a retailer or financial institution, and results in a score or other type of output that is representative of the transaction and that is produced by the processing system.

In the FIG. 3 representation, the transaction with the earliest time of transaction is at the top of the drawing figure and the newest, most recent transaction is at the bottom of the drawing figure. Thus, FIG. 3 shows that the transactions in the stream may be interleaved, with respect to the transaction groups with which they are associated. For example, the first transaction in the Group 2 group of transactions is received before the last transaction in the Group 1 group of transactions is received. FIG. 3 also shows that a last transaction in Group 1 may be received in the midst of (i.e., before and after) transactions in Groups 2 and 3 are received. In this way, transactions in one group may be received and processed before and after transactions in other groups are received and processed. Nevertheless, each group will have a first transaction and a last transaction, normally the first transaction in a group is a transaction associated with group header data for the group, and the last transaction in a group is a transaction associated with trailer data for the group.

In FIG. 3, transactions in the sequence that are designated as group trailers initiate generating a transaction group score or output that is based on all of the transactions preceding that group trailer that are in the associated group. For example, the transaction identified as “Last Transaction in Group 3” produces a transaction group score that is based on all the transactions in Group 3 that are shown in the sequence 300 beginning with the transaction identified as “First Transaction in Group 3”; that is, the score produced for Group 3 will include data from the transactions between the transaction identified as “First Transaction in Group 3” and “Last Transaction in Group 3”, not including data from any transactions that are not identified with Group 3.

FIG. 4 is a flow diagram showing an example of the Transaction Group Processing and Scoring Flow processing performed by the system illustrated in FIG. 1. In FIG. 4, the flow diagram illustrates how the transaction sequence shown in FIG. 3 is received by the transaction system depicted in FIG. 1 for transaction group processing and scoring. The transaction stream of financial transactions is received at box 402. For each financial transaction in the transaction steam, the transactions system checks to determine if the transaction is designated as the first transaction in a group. That is, at the decision box numbered 404, the system checks each transaction to determine if the transaction being processed indicates the transaction is the first transaction in a new transaction group. If the transaction is indicated as the first in a new group, an affirmative outcome at the box 404, then at box 406 the system performs a process to initialize a transaction group signature for the indicated group, as described further below. If the transaction is not the first in a new group, meaning that the transaction group signature has already been initialized, and also after the transaction group signature initialization 406 is completed, then the system processing continues at box 408 for transaction group signature update and transaction scoring. Such processing is described further below. The arrow leading from out of the box 408 indicates that the box 408 processing results in a score for the transaction. As noted previously, such scores are used in decision making for transactions.

After the box 408 processing is completed, the system checks each transaction to determine if the transaction was indicated as the last in a group. This checking is indicated by the decision box numbered 410. If the transaction being checked is not the last in a group, a negative outcome at box 410, then system processing returns to box 404 for processing the next transaction and performing the operations described above. If the transaction being checked is the last in a group, an affirmative outcome at the decision box 410, then system processing continues at box 412 for transaction group aggregation and scoring for the group. The arrow leading from out of the right side of the box 412 indicates that the box 412 processing results in a score for the transaction group. After the box 412, system processing continues with the next transaction data, at box 402, where the next transaction in the transaction stream is processed.

FIG. 5 is a flow diagram representation of an example of the transaction group signature initialization processing 406 noted in FIG. 4 and performed by the system illustrated in FIG. 1. Each transaction in the transaction stream 300 is associated with an identifier of a transaction group. If a transaction is received that has no corresponding group signature for the transaction group, then the process depicted in FIG. 5 is performed. The box 502 summarizes the three operations performed for group signature initialization. The group signature initialization process includes the operations listed in box 502 and below in Operation List 1:

Operation List 1
Step 1. Fetch signatures of pertinent entities related to the transaction group from the group signature database 504. For example, if entities relevant to a particular implementation of the system are customers, accounts, users, or the like, then the signatures for the corresponding customer, account, and user that are associated with the transaction group are deemed pertinent and are retrieved.
Step 2. Initialize the group signature 506:
   a. Collect/summarize entity-level information from the retrieved entity signatures.
   b. Store entity-level information in the group signature as a relevant-entity vector.
Step 3. Push the initialized group signature into the group signature database 508.
   Details of the transaction group signature data will depend on the operation of the system processing the transactions. The group signature data identifier value, for example, may be an alphanumeric character or string of such characters, or the group signature identifier value may be a value that is generated from data contained in each of the transactions. The group-ID should be either explicitly present on the transaction or computed from data elements that are explicitly present on the transaction. This ID will serve as a look-up key in the group-signature database when new transactions come in.

FIG. 6 is a flow diagram representation showing an example of transaction group signature update and transaction scoring processing 408 noted in FIG. 4 and performed by the system illustrated in FIG. 1. Upon receipt of a transaction in a group for which a transaction group signature already exists in the group signature database 508 (FIG. 5), the transaction group signature is retrieved from the database, is updated, and then is saved back to the database. The box 602 summarizes the operations performed for group signature update. Determining the group signature update comprises the operations listed in box 602 and below in Operation List 2:

Operation List 2
Step 1. Fetch transaction group signature from the group signature database 603.
Step 2. [Optional] Fetch signatures of pertinent entities related to the transaction group from the signature database 606.
Step 3. Update the group signature 604:
   a. Update summary statistics.
   b. Store the transaction data in the updated group signature value, stored within a transaction array.
Step 4. Store the updated group signature value into the group signature database 603.
Step 5. [Optional] Calculate a model output and/or transaction score based on the group signature value and any other desired signature data of the system.
Step 6. [Optional] Update any other desired signature data and store into corresponding databases.
   With respect to the summary statistics in Step 3, some common summary statistics might include data such as the number of transactions in the group, total amount of transactions, financial “velocity” and “accelerations” in the group, standard deviations and other moments of the transaction amounts or times in the group, and the like. The transaction arrays will contain information of each of the transactions, selected based on the application domain, such as amount, date/time, and other characteristics. Those skilled in the art will understand that further details would be highly dependent on the particular domain or application involved.

The retrieved transaction group signature data (the first operation in Operation List 2, and depicted as Step 1 in FIG. 6) may include data from a relevant-entity vector, group summary statistics, and a group transaction array, which may be retrieved from a system store and are operated upon in a group signature determination process 604.

Step 2 in FIG. 6 is optional, and accommodates the situation where signature types other than group signatures are utilized, such as signatures that are specific to the individual transaction. Such alternative or additional signature types may be retrieved from appropriate signature databases 606 of the system, an operation indicated as Step 2.

In some embodiments, group-level summary statistics can be saved in the group signature data. The operation 3(a) of Operation List 2 shows that the information received from a transaction in a transaction group is used to update group-level summary statistics, which may be saved in the group signature. The operation 3(b) of Operation List 2 shows that the details of the transaction may be kept in the group signature as well, in a transaction array. These two operations are depicted as Step 3 in FIG. 6. Step 4 indicates that the updated group signature value is stored into the group signature database 603.

Optionally (see operation 5 in Operation List 2), a score that corresponds to the transaction is computed, based on the information in any other signatures retrieved in operation 2 of Operation List 2, and based on the information contained in the group signature data. Additionally, and optionally (at operation 6 of Operation List 2), a score or other predetermined system output for transaction processing may be produced for the transaction and stored back into appropriate signature databases 606 of the system. The group signature database can be stored in a particular table in the signature database. Signatures of different entities can be stored in a single database with different table, such as one for each entity.

FIG. 7 is a flow diagram representation of transaction group aggregation and scoring processing 412 noted in FIG. 4 and performed by the system illustrated in FIG. 1. FIG. 7 shows that a score for a transaction group may be initiated by an explicit group-scoring request, by a transaction in a group that by default includes a directive requesting a group score when processing the transaction, or by a transaction that explicitly indicates the end of the transaction group that includes a directive requesting a group score. Upon receipt of such a transaction, the process depicted in FIG. 7 is performed. The box 702 summarizes the operations performed for transaction group aggregation and scoring. Determining the group scoring comprises the operations listed below in Operation List 3:

Operation List 3
Step 1. Fetch signatures of pertinent entities related to the transaction group from the database 703.
Step 2. [Optional] Update group signature data for the transaction group.
Step 3. Aggregate the transaction group information and create a transaction group vector 706.
Step 4. Update the fetched pertinent entity signatures with the transaction group vectors 706.
Step 5. Determine a score 708 for the transaction group based on any and/or all information in the system. The decision to include or exclude information from being used in score determination varies depending on the inputs of the analytical scoring model used in the system.
Step 6. Store entity signature data into the corresponding signature databases 703.
Step 7. [Optional] Delete group signature data from corresponding databases.

Step 1 of the FIG. 7 process (the first operation in the box 704) indicates that entity level signatures that were only once retrieved during the group signature initialization 406 (FIG. 4) are again retrieved from the signature databases 703 of the system. The set of signature databases 703 may be the same set as in the database 606 (FIG. 6) or they may be different sets.

Step 2 in FIG. 7 leading to the group signature process 706 (the second operation of Operation List 3) indicates that, if there is information in the financial transaction that initiated the group-scoring process that should be used to update either the group level summary statistics or the transaction array in the group signature, then such an update is performed prior to the remaining processing operations of Operation List 3. Step 3 depicted in the group signature box 706 (third operation of Operation List 3) indicates that all of the information present in the group signature is summarized into a “Persistent group summary” represented as the transaction group vector. It is this summarized information that is saved to the entity level signatures, as represented by Step 4 leading back to the group signature scoring operation 704.

Step 5 indicates that a group level transaction score or system output is computed from all appropriate information in the system. Such appropriate information would typically include entity level signature data, the group level signature data, and the financial transaction data that initiated the group scoring process. Step 6 indicates that the computed group level transaction score is stored into the signature databases 702. Step 7 indicates an optional process in which the group signature data is deleted from the group signature database. That is, if the optional Step 7 is performed, then the given transaction group signature can be deleted from the database upon the scoring of such transaction group. The re-computing/update of the group signature is performed when the transactions within the group are still being processed. Once the processing of the group trailer transactions and the corresponding group signature are completed, no further update and no further usage (except, e.g., for system monitoring/quality assurance checking) is performed.

Exemplary Hardware System

The systems and methods described above may be implemented in a number of ways. One such implementation includes computer devices having various electronic components. For example, components of the system in FIG. 1 may, individually or collectively, be implemented with devices having one or more Application Specific Integrated Circuits (ASICs) adapted to perform some or all of the applicable functions in hardware. Alternatively, the functions may be performed by one or more other processing units (or cores), on one or more integrated circuits or processors in programmed computers. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific computer processors.

FIG. 8 provides a block diagram of a computer system 800 for implementing certain functions and operations as described herein. The computer system 800 may implement, for example, any one or all of the transaction services system 102, user computer 104, transaction application 110, transactions database 112, and signatures database 114 illustrated in FIG. 1. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The system 800 is shown comprising hardware elements that can be electrically coupled via a system bus 826 (or may otherwise be in communication, as appropriate). The hardware elements can include one or more central processor units (CPUs) 802, including without limitation one or more general-purpose processors and/or one or more special-purpose processors (such as communication processing chips, graphics acceleration chips, and/or the like); one or more input devices 804, that can include, without limitation, a mouse, a keyboard, and/or the like; and one or more output devices 806, which can include without limitation a display device, a printer, audio device, and/or the like.

The computer system 800 may further include (and/or be in communication with) one or more storage devices 808, which can comprise, without limitation, local and/or network accessible storage and/or can include, without limitation, a disk drive, a drive array, an optical storage device, solid-state storage device such as a random access memory (“RAM”), and/or a read-only memory (“ROM”), which can be programmable, flash-updateable, and/or the like. The computer system 800 might also include a communications subsystem 814, which can include without limitation a modem, a network card (wireless or wired), an infra-red communication device, a wireless communication device and/or chipset (such as a Bluetooth device, an 802.11 device, a WiFi device, a WiMax device, cellular communication facilities, etc.), and/or the like. The communications subsystem 814 may permit data to be exchanged with a network 815, and/or any other devices described herein. The network 815 may comprise a local area network (LAN) or a network such as the Internet, or a combination. In many embodiments, the computer system 800 will further include a working memory 818, which can include a RAM or ROM device, as described above.

The computational system 800 also may comprise software elements, shown as being currently located within the working memory 818, including an operating system 824 and/or other program code, such as one or more application programs 822, which may comprise computer programs performing tasks and operations described above, and/or may be designed to implement methods in accordance with the disclosed subject matter and/or systems in accordance with the disclosed subject matter, as described herein. Merely by way of example, one or more procedures described with respect to the method(s) discussed above might be implemented as code and/or instructions executable by a computer (and/or a processor within a computer). In one embodiment, the data generating and presenting operations are implemented as application programs 822. In the description herein, references to “interface” and “processor” and “application” should be understood as referring to hardware, software, and combinations of the two, either as independent components (hardware, software, and/or both) for each interface, processor, or application, or as integrated components combined with one or more other components.

A set of these instructions and/or code may be stored on a computer readable storage medium 810b. In some embodiments, the computer readable storage medium 810b may comprise the storage device(s) 808 described above. In other embodiments, the computer readable storage medium 810b might be incorporated within the computer system. In still other embodiments, the computer readable storage medium 810b might be separate from the computer system (i.e., it may be a removable readable medium, such as a compact disc, etc.), and or might be provided in an installation package, such that the storage medium can be used to program a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code. In these embodiments, the computer readable storage medium 810b may be read by a computer readable storage media reader 810a.

It will be apparent that variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one embodiment, local and remote computer systems (such as the computer system 800) are utilized to perform methods of the disclosed subject matter. According to a set of embodiments, some or all of the procedures of such methods are performed by the computer system 800 in response to the processor 802 executing one or more sequences of one or more instructions (which might be incorporated into the operating system 824 and/or other code, such as an application program 822) contained in the working memory 818. Such instructions may be read into the working memory 818 from another machine-readable medium, such as one or more of the storage device(s) 808 (or 810). Merely by way of example, execution of the sequences of instructions contained in the working memory 818 might cause the processor(s) 802 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 800, various machine-readable media might be involved in providing instructions/code to processor(s) 802 for execution and/or might be used to store and/or carry such instructions/code (e.g., as data transmissions or data communications). In many implementations, a computer readable medium is a physical and/or tangible storage medium. Such a medium may take many forms, including but not limited to, volatile and non-volatile media. Non-volatile computer-readable media includes, for example, optical or magnetic disks, such as the storage device(s) (808 or 810). Volatile computer-readable media includes, without limitation, dynamic memory, such as the working memory 818. In some implementation, data may be carried over transmission media. Transmission media includes coaxial cables, copper wire, and fiber optics, including the wires that comprise the bus 826, as well as the various components of the communication subsystem 814 (and/or the media by which the communications subsystem 814 provides communication with other devices). Hence, transmission media can also take the form of waves (including, without limitation, radio, acoustic, and/or light waves, such as those generated during radio-wave and infra-red data communications).

Common forms of physical and/or tangible non-volatile computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, or any other medium from which a computer can read instructions and/or code.

Various forms of machine-readable media may be involved in carrying one or more sequences of one or more instructions to the processor(s) 802 for execution. Merely by way of example, the instructions may initially be carried on a magnetic disk and/or optical disc of a remote computer. A remote computer might load the instructions into its dynamic memory and send the instructions communications over a transmission medium to be received and/or executed by the computer system 800. These communications, which might be in the form of electromagnetic communications, acoustic communications, optical communications, and/or the like, are all examples of carrier waves on which instructions can be encoded, in accordance with various embodiments of the disclosed subject matter.

The communications subsystem 814 (and/or components thereof) generally will receive the communications, and the bus 826 then might carry the communications (and/or the data, instructions, etc. carried by the communications) to the working memory 818, from which the processor(s) 802 retrieves and executes the instructions. The instructions received by the working memory 818 may optionally be stored on a storage device 808 either before or after execution by the processor(s) 802.

It will be appreciated that many processing capabilities in addition to those described are possible, without departing from the teachings according to the disclosed subject matter. Further, it should be noted that the methods, systems, and devices discussed above are intended merely to be examples. Various embodiments may omit, substitute, or add various procedures or components as appropriate. For example, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the disclosed subject matter.

Specific details are given in the description to provide a thorough understanding of the embodiments. However, it will be understood by one of ordinary skill in the art that the embodiments may be practiced without these specific details.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figures.

Other variations are within the spirit of the present disclosed subject matter. Thus, while the disclosed subject matter is susceptible to various modifications and alternative constructions, certain illustrated embodiments thereof are shown in the drawings and have been described above in detail. It should be understood, however, that there is no intention to limit the disclosed subject matter to the specific form or forms disclosed, but on the contrary, the intention is to cover all modifications, alternative constructions, and equivalents falling within the spirit and scope of the disclosed subject matter, as defined in the appended claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A computer-implemented method, comprising:
receiving a transaction in a sequence of transactions and determining, with one or more processors, a transaction group with which the transaction is associated;
determining transaction group signature data of the transaction group with which the received transaction is associated;
generating a transaction score for the received transaction;
in response to determining that the received transaction is a last transaction in the transaction group with which the received transaction is associated, generating a transaction group score for the transaction group with which the received transaction is associated, such that the transaction group score is generated based on all transactions in the sequence of transactions that are associated with the transaction group.

2. The method of claim 1, further comprising providing the transaction score for the received transaction prior to receiving a next transaction in the sequence of transactions.

3. The method of claim 1, wherein the transaction group score of the transaction group is generated independently of transactions in the sequence of transactions that are not associated with the transaction group.

4. The method of claim 1, further comprising performing a group signature initialization process for a new transaction group, wherein the signature initialization process comprises:
retrieving a set of signatures related to the new transaction group, wherein the set is retrieved from a signature database;
determining entity level information using the retrieved set of signatures;
generating an entity vector using the determined entity level information; and
storing the entity vector as new transaction group signature data for the new transaction group.

5. The method of claim 1, further comprising updating the transaction group signature data for the associated transaction group, wherein updating the transaction group signature data comprises:
retrieving group signature data for the transaction group, wherein the group signature data is retrieved from a group signature database;
updating transaction group summary statistics associated with the retrieved group signature data; and
storing the updated group level summary statistics for the group signature data in the group signature database and storing the transaction in a transaction array of the group signature database.

6. The method of claim 5, wherein retrieving group signature data includes retrieving signature data corresponding to one or more entities.

7. The method of claim 5, further comprising:
generating the transaction score in accordance with a model that includes data relating to the transaction group signature data and signature data types.

8. The method of claim 4, further comprising performing a group signature initialization process in response to determining that the received transaction is associated with group header data that indicates the received transaction is part of the new transaction group.

9. The method of claim 1, wherein generating the transaction group score comprises:
retrieving a set of signatures related to the transaction group, wherein the set is retrieved from a signature database;
aggregating transaction group signature data associated with the transaction group and aggregating entity level signature data from the retrieved set of signatures;
generating a transaction group vector using the aggregated transaction group signature data;
updating the transaction group signature data using the transaction group vector; and
generating the transaction group aggregate score using the transaction group signature data and using the entity level signature data.

10. The method of claim 9, further comprising:
storing the updated transaction group signature data, wherein the updated transaction group signature data is stored in the group signature database.

11. The method of claim 9, wherein the retrieved transaction group signature data comprises:
an entity vector, wherein the entity vector is retrieved from the group signature database;
group summary statistics from the group signature database; and
a group transaction array from the group signature database.

12. The method of claim 9, wherein aggregating transaction group signature data further comprises:
updating the entity level signature data.

13. The method of claim 9, wherein aggregating transaction group signature data further comprises:
deleting the transaction group signature data from the signature database.

14. The method of claim 7, further comprising:
updating the transaction group signature data using the current transaction before generating the transaction group vector.

15. A system comprising:
one or more processors;
one or more non-transitory computer-readable storage mediums containing executable instructions configured to cause the one or more processors to perform operations when executed, the operations comprising:
processing a transaction in a sequence of transactions received at a computing device, and determining a transaction group with which the transaction is associated;
determining transaction group signature data of the transaction group with which the received transaction is associated;
generating a transaction score for the received transaction;
generating a transaction group score for the transaction group with which the received transaction is associated, in response to determining that the received transaction is a last transaction in the transaction group, such that the transaction group score is generated based on all transactions in the sequence of transactions that are associated with the transaction group.

16. The system of claim 15, further including instructions configured to cause the one or more processors to perform operations further comprising:
providing the transaction score for the received transaction prior to receiving a next transaction in the sequence of transactions.

17. The system of claim 15, wherein the transaction group score of the transaction group is generated independently of transactions in the sequence of transactions that are not associated with the transaction group.

18. The system of claim 15, further including instructions configured to cause the one or more processors to perform operations for performing a group signature initialization process for a new transaction group, wherein the signature initialization process comprises:
retrieving a set of signatures related to the new transaction group, wherein the set is retrieved from a signature database;
determining entity level information using the retrieved set of signatures;
generating an entity vector using the determined entity level information; and
storing the entity vector as new transaction group signature data for the new transaction group.

19. The system of claim 15, further including instructions configured to cause the one or more processors to perform operations for updating the transaction group signature data for the associated transaction group, wherein updating the transaction group signature data comprises:
retrieving group signature data for the transaction group, wherein the group signature data is retrieved from a group signature database;
updating transaction group summary statistics associated with the retrieved group signature data; and
storing the updated group level summary statistics for the group signature data in the group signature database and storing the transaction in a transaction array of the group signature database.

20. The system of claim 19, wherein retrieving group signature data includes retrieving signature data corresponding to one or more entities.

21. The system of claim 19, further including instructions configured to cause the one or more processors to perform operations further comprising:
generating the transaction score in accordance with a model that includes data relating to the transaction group signature data and signature data types.

22. The system of claim 18, further including instructions configured to cause the one or more processors to perform operations further comprising performing a group signature initialization process in response to determining that the received transaction is associated with group header data that indicates the received transaction is part of the new transaction group.

23. The system of claim 15, wherein generating the transaction group score comprises:
retrieving a set of signatures related to the transaction group, wherein the set is retrieved from a signature database;
aggregating transaction group signature data associated with the transaction group and aggregating entity level signature data from the retrieved set of signatures;
generating a transaction group vector using the aggregated transaction group signature data;
updating the transaction group signature data using the transaction group vector; and
generating the transaction group aggregate score using the transaction group signature data and using the entity level signature data.

24. The system of claim 23, further comprising:
storing the updated transaction group signature data, wherein the updated transaction group signature data is stored in the group signature database.

25. The system of claim 23, wherein the retrieved transaction group signature data comprises:
an entity vector, wherein the entity vector is retrieved from the group signature database;
group summary statistics from the group signature database; and
a group transaction array from the group signature database.

26. The system of claim 23, wherein aggregating transaction group signature data further comprises:
updating the entity level signature data.

27. The system of claim 23, wherein aggregating transaction group signature data further comprises:
deleting the transaction group signature data from the signature database.

28. The system of claim 22, wherein generating the transaction group score further comprises:
updating the transaction group signature data using the current transaction before generating the transaction group vector

29. A computer program product, tangibly embodied in a non transitory machine-readable storage medium, the medium including instructions configured to cause a data processing system to perform operations comprising:
processing a transaction in a sequence of transactions received at a computing device, and determining a transaction group with which the transaction is associated;
determining transaction group signature data of the transaction group with which the received transaction is associated;
generating a transaction score for the received transaction;
generating a transaction group score for the transaction group with which the received transaction is associated, in response to determining that the received transaction is a last transaction in the transaction group, such that the transaction group score is generated based on all transactions in the sequence of transactions that are associated with the transaction group.

30. The computer program product of claim 29, further including instructions configured to cause the one or more processors to perform operations further comprising:
providing the transaction score for the received transaction prior to receiving a next transaction in the sequence of transactions.

31. The computer program product of claim 29, wherein the transaction group score of the transaction group is generated independently of transactions in the sequence of transactions that are not associated with the transaction group.

32. The computer program product of claim 29, further including instructions configured to cause the one or more processors to perform operations for performing a group signature initialization process for a new transaction group, wherein the signature initialization process comprises:
retrieving a set of signatures related to the new transaction group, wherein the set is retrieved from a signature database;
determining entity level information using the retrieved set of signatures;
generating an entity vector using the determined entity level information; and
storing the entity vector as new transaction group signature data for the new transaction group.

33. The computer program product of claim 29, further including instructions configured to cause the one or more processors to perform operations for updating the transaction group signature data for the associated transaction group, wherein updating the transaction group signature data comprises:
retrieving group signature data for the transaction group, wherein the group signature data is retrieved from a group signature database;
updating transaction group summary statistics associated with the retrieved group signature data; and
storing the updated group level summary statistics for the group signature data in the group signature database and storing the transaction in a transaction array of the group signature database.

34. The computer program product of claim 33, wherein retrieving group signature data includes retrieving signature data corresponding to one or more entities.

35. The computer program product of claim 33, further including instructions configured to cause the one or more processors to perform operations further comprising:
generating the transaction score in accordance with a model that includes data relating to the transaction group signature data and signature data types.

36. The computer program product of claim 32, further including instructions configured to cause the one or more processors to perform operations further comprising performing a group signature initialization process in response to determining that the received transaction is associated with group header data that indicates the received transaction is part of the new transaction group.

37. The computer program product of claim 29, wherein generating the transaction group score comprises:
retrieving a set of signatures related to the transaction group, wherein the set is retrieved from a signature database;
aggregating transaction group signature data associated with the transaction group and aggregating entity level signature data from the retrieved set of signatures;
generating a transaction group vector using the aggregated transaction group signature data;
updating the transaction group signature data using the transaction group vector; and
generating the transaction group aggregate score using the transaction group signature data and using the entity level signature data.

38. The computer program product of claim 37, further comprising:
storing the updated transaction group signature data, wherein the updated transaction group signature data is stored in the group signature database.

39. The computer program product of claim 37, wherein the retrieved transaction group signature data comprises:
an entity vector, wherein the entity vector is retrieved from the group signature database;
group summary statistics from the group signature database; and
a group transaction array from the group signature database.

40. The computer program product of claim 37, wherein aggregating transaction group signature data further comprises:
updating the entity level signature data.

41. The computer program product of claim 37, wherein aggregating transaction group signature data further comprises:
deleting the transaction group signature data from the signature database.

42. The computer program product of claim 37, wherein generating the transaction group score comprises updating the transaction group signature data using the current transaction before generating the transaction group vector.
